(19) United States
(12) Patent Application Publication
(10) Pub. No.: US 2026/0067481 A1
(43) Pub. Date: Mar. 5, 2026

(54) METHOD AND APPARATUS FOR STORING VIDEO DATA, DEVICE, STORAGE MEDIUM, AND PROGRAM PRODUCT

(71) Applicant: Glenfly Tech Co., Ltd., Shanghai (CN)

(72) Inventors: Ao MEI, Shanghai (CN); Chuanchuan ZHU, Shanghai (CN); Jin SHAO, Shanghai (CN)

(21) Appl. No.: 19/293,914

(22) Filed: Aug. 7, 2025

(30) Foreign Application Priority Data
Sep. 3, 2024 (CN) 202411232030.5

(51) Int. Cl. H04N 19/423; H04N 19/105; H04N 19/156; H04N 19/176; H04N 19/44

(52) U.S. Cl. CPC H04N 19/423; H04N 19/105; H04N 19/156; H04N 19/176; H04N 19/44

(57) ABSTRACT

The present disclosure relates to a method and an apparatus for storing video data, a computer device, a computer-readable storage medium, and a computer program product. The method includes: establishing a lookup table corresponding to a time domain collocated reference block, wherein the lookup table comprises any one of a picture order count difference lookup table, or a picture order count lookup table of a reference frame; storing the lookup table corresponding to the time domain collocated reference block; establishing an index corresponding to the lookup table; and when decoding is performed according to coding units, acquiring stored data from the lookup table corresponding to the time domain collocated reference block through the index corresponding to the lookup table.

### CROSS-REFERENCE TO RELATED APPLICATION

This application claims priority to Chinese Patent Application No. 202411232030.5, filed with the China National Intellectual Property Administration and entitled “Method and Apparatus for Storing Video Data, Device, Storage Medium, and Program Product” on Sep. 3, 2024, which is incorporated herein by reference in its entirety.

### TECHNICAL FIELD

The present disclosure relates to the field of data storage technology, particularly to a method and an apparatus for storing video data, a computer device, a computer-readable storage medium, and a computer program product.

### BACKGROUND

With the development of video technology, storage technologies for various video data appear. H.266/VVC (Versatile Video Coding) is a next-generation video coding and decoding standard, compared to the previous-generation standard H.265/HEVC (High Efficiency Video Coding), the H.266/VVC further improves the compression efficiency, and provides better support especially for new applications such as 8K ultra-HD, screen, high-dynamic, and 360-degree panoramic video, etc. Similar to the previous generation standard H.265/HEVC, the H.266/VVC is also based on the block compression, that is, a frame of image is first partitioned according to a size of a coding tree unit (CTU), then a coding unit (CU) partition is performed in units of CTUs, and finally coding is performed in units of CUs. In an inter-frame prediction mode, the decoder needs to derive a motion vector for the CU, and there are multiple modes for deriving the motion vector, one of which is to scale a motion vector of a collocated reference block in a time domain collocated reference frame to obtain a motion vector prediction value of a current CU. In order to obtain the motion vector scaleMV after the scaling of the current CU, a difference (that is, a picture order count difference, referred to as a Delta POC,) between the time domain collocated reference frame POC_COL and the reference frame colRefPOC of the time domain collocated reference block, and the motion vector colMV of the collocated reference block in the time domain collocated reference frameneed to be stored. In the VVC standard, the Delta POC requires 16 bits to store, and the colMV requires 40 bits to store. In the VVC standard, a storage granularity of the Delta POC and the colMV is 8×8. Compared to the 16×16 storage granularity for the previous-generation standard HEVC, it may occupy a larger amount of memory access bandwidth to store the Delta POC and the colMV of the collocated reference block in the VVC standard.

However, in the existing solution, each collocated reference block stores one Delta POC by itself. A resolution of 4096×2160 is taken as an example, a data size for storing the Delta POC of one frame of collocated reference block in the VVC standard and the HEVC standard is respectively provided as follows:

$$DeltaPOCSize\_VVC = 4096 \times 2160 / 64 \times 16 = 2211840 bit \\ DeltaPOCSize\_HEVC = 4096 \times 2160 / 256 \times 16 = 552960 bit$$

where DeltaPOCSize_VVC represents the data amount in the VVC standard, DeltaPOCSize_HEVC represents the data amount in the HEVC standard, and bit is the unit bit.

Suppose the decoder may decode 60 frames per second, the bandwidth occupied by storing and reading the Delta POC in the VVC and HEVC standards is respectively provided as follows:

$$WRBandW\_VVC = 2211840 \times 60 \times 2 = 265.42 Mbit / s \\ WRBandW\_HEVC = 552960 \times 60 \times 2 = 66.36 Mbit / s$$

where WRBandW_VVC represents the bandwidth occupied by storing and reading the Delta POC in the VVC standard, WRBandW_HEVC represents the bandwidth occupied by storing and reading the Delta POC in the HEVC standard, and Mbit/s represents a megabit per second.

To sum up, it can be learned that, if the Delta POC of the collocated reference block is stored according to the solution in the HEVC standard, a large quantity of memory access bandwidth may be occupied in the VVC standard compared to the HEVC standard.

### SUMMARY

In view of this, in order to address the above technical problem, it is necessary to provide a method and an apparatus for storing video data, a computer device, a computer-readable storage medium, and a computer program product capable of effectively reducing the memory access bandwidth.

In the first aspect of the present disclosure, a method for storing video data is provided, including: establishing a lookup table corresponding to a time domain collocated reference block, in which the lookup table comprises any one of a picture order count difference lookup table, or a picture order count lookup table of a reference frame, the picture order count difference lookup table is configured to store a difference between a picture order count and a reference frame picture order count thereof, and the picture order count lookup table of the reference frame is configured to store a picture order count of the reference frame; storing the lookup table corresponding to the time domain collocated reference block; establishing an index corresponding to the lookup table; and when decoding is performed according to coding units, acquiring stored data from the lookup table corresponding to the time domain collocated reference block through the index corresponding to the lookup table.

In an embodiment, when the lookup table is the picture order count difference lookup table, establishing the lookup table corresponding to the time domain collocated reference block includes: transmitting forward and backward reference frame lists of a current frame to a decoder; when the current frame is not a frame B, acquiring, through the decoder, a picture order count of each reference frame in the forward reference frame list, subtracting the picture order count of the current frame therefrom to obtain a first picture order count difference, storing the first picture order count difference into the lookup table corresponding to the time domain collocated reference block; when the current frame is the frame B, acquiring, by the decoder, the picture order count of each reference frame in the forward reference frame list, subtracting the picture order count of the current frame to obtain the first picture order count difference, acquiring, through the decoder, a picture order count of each reference frame in the backward reference frame list, subtracting the picture order count of the current frame to obtain a second picture order count difference, performing a deduplication operation on the first picture order count difference and the second picture order count difference, obtaining a picture order count difference after the deduplication, and storing the picture order count difference after the deduplication into the lookup table corresponding to the time domain collocated reference block.

In an embodiment, when the lookup table is the picture order count lookup table of the reference frame, establishing the lookup table corresponding to the time domain collocated reference block includes: transmitting forward and backward reference frame lists of a current frame to a decoder; when the current frame is not a frame B, acquiring, through the decoder, a picture order count of each reference frame in the forward reference frame list, storing the picture order count of each reference frame in the forward reference frame list into the lookup table corresponding to the time domain collocated reference block; when the current frame is the frame B, acquiring, through the decoder, the picture order count of each reference frame in the forward reference frame list, acquiring, through the decoder, a picture order count of each reference frame in the backward reference frame list, performing a deduplication operation on the picture order count of each reference frame in the forward reference frame list and the picture order count of each reference frame in the backward reference frame list, obtaining a picture order count after the deduplication, and storing the picture order count after the deduplication into the lookup table corresponding to the time domain collocated reference block.

In an embodiment, storing the lookup table corresponding to the time domain collocated reference block includes: storing the lookup table corresponding to the time domain collocated reference block into an off-chip memory.

In an embodiment, when the lookup table is the picture order count difference lookup table, establishing the index corresponding to the lookup table includes: determining a position of a difference between a picture order count of a current frame and a picture order count of a reference frame of each decoding unit in the picture order count difference lookup table according to a preset sequence, obtaining an index of the picture order count difference lookup table; storing the index of the picture order count difference lookup table into an on-chip register, wherein a width of the on-chip register is the same as a width of a data bus accessing an off-chip memory, and storing data in the on-chip register into the off-chip memory when the on-chip register is full.

In an embodiment, when the lookup table is the picture order count lookup table of the reference frame, establishing the index corresponding to the lookup table includes: determining a position of a picture order count of a reference frame of each decoding unit in the picture order count lookup table of the reference frame according to a preset sequence, obtaining an index of the picture order count lookup table of the reference frame; storing the index of the picture order count lookup table of the reference frame into an on-chip register, wherein a width of the on-chip register is the same as a width of a data bus accessing an off-chip memory, and storing data in the on-chip register into the off-chip memory when the on-chip register is full.

In an embodiment, acquiring the stored data from the lookup table corresponding to the time domain collocated reference block through the index corresponding to the lookup table includes: when the decoding is performed on the current frame, reading the lookup table corresponding to the time domain collocated reference block and the index of the lookup table corresponding to the time domain collocated reference block from the off-chip memory; storing the read lookup table corresponding to the time domain collocated reference block and index of the lookup table corresponding to the time domain collocated reference block into the on-chip register; reading the index of the lookup table corresponding to the time domain collocated reference block from the on-chip register; determining a storage position of the difference between the picture order count of the collocated reference block and the picture order count of the reference frame of the collocated reference block in the lookup table corresponding to the time domain collocated reference block, or a storage position of the picture order count of the reference frame of the collocated reference block in the lookup table corresponding to the time domain collocated reference block according to the index of the lookup table corresponding to the time domain collocated reference block; and acquiring the difference between the picture order count of the collocated reference block and the picture order count of the reference frame of the collocated reference block, or the picture order count of the reference frame of the collocated reference block from the corresponding storage position.

In the second aspect of the present disclosure, an apparatus for storing video data is provided, including: a lookup table establishment module, configured to establish a lookup table corresponding to a time domain collocated reference block, in which the lookup table comprises any one of a picture order count difference lookup table, or a picture order count lookup table of a reference frame, the picture order count difference lookup table is configured to store a difference between a picture order count and a reference frame picture order count thereof, the picture order count lookup table of the reference frame is configured to store a picture order count of the reference frame; a storage module, configured to store the lookup table corresponding to the time domain collocated reference block; an index establishment module, configured to establish an index corresponding to the lookup table; and a data acquisition module, configured to acquire stored data from the lookup table corresponding to the time domain collocated reference block through the index corresponding to the lookup table when decoding is performed according to coding units.

In the third aspect of the present disclosure, a computer device is provided, including a processor and a memory storing a computer program, the processor, when executing the computer program, implements the method of: establishing a lookup table corresponding to a time domain collocated reference block, in which the lookup table comprises any one of a picture order count difference lookup table, or a picture order count lookup table of a reference frame, the picture order count difference lookup table is configured to store a difference between a picture order count and a reference frame picture order count thereof, and the picture order count lookup table of the reference frame is configured to store a picture order count of the reference frame; storing the lookup table corresponding to the time domain collocated reference block; establishing an index corresponding to the lookup table; and when decoding is performed according to coding units, acquiring stored data from the lookup table corresponding to the time domain collocated reference block through the index corresponding to the lookup table.

In the fourth aspect of the present disclosure, a computer-readable storage medium is provided, on which a computer program is stored, the computer program, when executed by a processor, causes the processor to implement the method of: establishing a lookup table corresponding to a time domain collocated reference block, in which the lookup table comprises any one of a picture order count difference lookup table, or a picture order count lookup table of a reference frame, the picture order count difference lookup table is configured to store a difference between a picture order count and a reference frame picture order count, and picture order count lookup table of the reference frame is configured to store a picture order count of the reference frame; storing the lookup table corresponding to the time domain collocated reference block; establishing an index corresponding to the lookup table; and when decoding is performed according to coding units, acquiring stored data from the lookup table corresponding to the time domain collocated reference block through the index corresponding to the lookup table.

In the fifth aspect of the present disclosure, a computer program product is provided, including a computer program, the computer program, when executed by a processor, causes the processor to implement the method of: establishing a lookup table corresponding to a time domain collocated reference block, in which the lookup table comprises any one of a picture order count difference lookup table, or a picture order count lookup table of a reference frame, the picture order count difference lookup table is configured to store a difference between a picture order count and a reference frame picture order count thereof, and the picture order count lookup table of the reference frame is configured to store a picture order count of the reference frame; storing the lookup table corresponding to the time domain collocated reference block; establishing an index corresponding to the lookup table; and when decoding is performed according to coding units, acquiring stored data from the lookup table corresponding to the time domain collocated reference block through the index corresponding to the lookup table.

With the above-mentioned method and apparatus for storing the video data, the computer device, the computer-readable storage medium, and the computer program product, a lookup table corresponding to a time domain collocated reference block is established, the lookup table includes any one of a picture order count difference lookup table, or a picture order count lookup table of a reference frame. The picture order count difference lookup table is configured to store a difference between a picture order count and a reference frame picture order count thereof. The picture order count lookup table of the reference frame is configured to store a picture order count of the reference frame. Accordingly, the picture order count difference and the picture order count of the reference frame may be stored in the mode of data table, so that an index is subsequently established for looking up. By storing the lookup table corresponding to the time domain collocated reference block, and establishing an index corresponding to the lookup table, multiple different picture order count differences and reference frame picture order counts can be looked up in an index mode, and only the index of the lookup table can be stored in the on-chip register, thereby greatly reducing the occupation of memory access bandwidth in the VVC standard. When decoding is performed according to the coding units, the stored data is acquired from the lookup table corresponding to the time domain collocated reference block through the index corresponding to the lookup table. Accordingly, a memory access bandwidth occupied by a position in a frame-level picture order count difference lookup table is allowed to be only one-fourth of a memory access bandwidth occupied by a directly stored picture order count difference, thereby effectively reducing the memory access bandwidth and improving the image display performance.

### BRIEF DESCRIPTION OF THE DRAWINGS

In order to describe the technical solution in the embodiments of the present disclosure or the related technologies more clearly, the accompanying drawings required for describing the embodiments of the present disclosure or the related technologies are briefly introduced. Obviously, the accompanying drawings in the following description show merely some embodiments of the present disclosure, and those skilled in the art may still obtain other related drawings according to these accompanying drawings without any creative efforts.

FIG. 1 is a schematic principle diagram of performing a CU division in units of CTUs according to an embodiment.

FIG. 2 is a schematic diagram of a corresponding relationship between motion vectors of a collocated reference block according to an embodiment.

FIG. 3 is a flow chart showing a method for storing video data according to an embodiment.

FIG. 4 is a schematic diagram of constructing a lookup table corresponding to a time domain collocated reference block according to an embodiment.

FIG. 5 is a schematic diagram of constructing a lookup table corresponding to a time domain collocated reference block according to another embodiment.

FIG. 6 is an implementation flowchart of a Delta POC lookup table according to an embodiment.

FIG. 7 is an implementation flowchart of a reference frame POC lookup table according to another embodiment.

FIG. 8 is a schematic structure block diagram illustrating an apparatus for storing video data according to an embodiment.

FIG. 9 is an internal structure diagram of a computer device according to an embodiment.

### DETAILED DESCRIPTION OF THE EMBODIMENTS

In order to make the purpose, technical solution and advantages of the present disclosure more clearly understood, the present disclosure is further described in detail below in conjunction with the accompanying drawings and embodiments. It should be appreciated that the specific embodiments described herein are merely used for illustrating the present disclosure, rather than limiting the present disclosure.

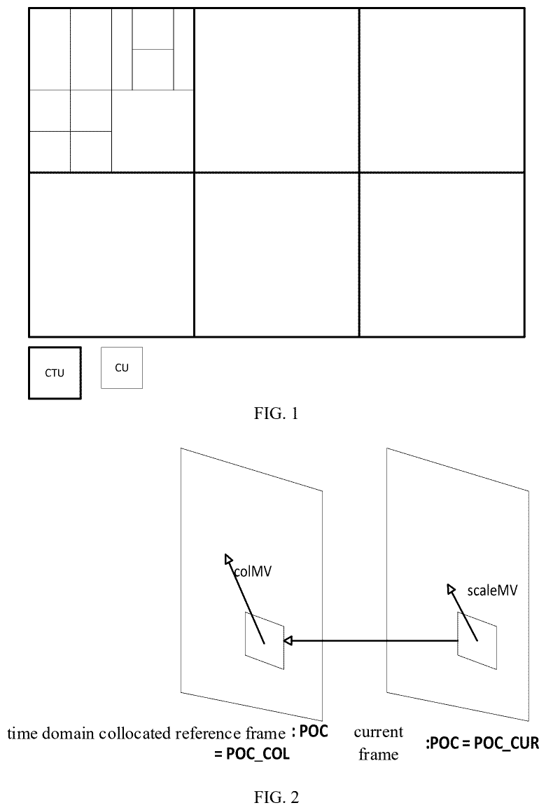

In an embodiment of the present disclosure, a method for storing video data is provided, which may be adapted to the H.266/VVC standard. As shown in FIG. 1, FIG. 1 shows a schematic principle diagram of performing a coding unit (CU) division in units of CTUs and performing coding on a CTU in units of CUs. There are two final prediction modes for each CU, namely an intra-frame angle prediction mode and an inter-frame prediction mode. In the inter-frame prediction mode, a decoder needs to derive a motion vector for the CU, and the motion vector can be derived in many modes, one of which is to scale a motion vector of a collocated reference block in a time domain collocated reference frame to obtain a motion vector prediction value of the current CU. A position of the collocated reference block in the time domain collocated reference frame is shown in FIG. 2. Specifically, a theoretical calculation relationship between the scaled motion vector scaleMV and the motion vector colMV of the collocated reference block in the time domain collocated reference frame is provided as follows:

$$scaleMV = \frac{POC\_CUR - curRefPOC}{POC\_COL - curRefPOC} \times coMV \qquad ( 1 )$$

In the formula, POC_CUR represents a Picture Order Count (POC) of a current frame, POC_COL represents a POC of a time domain collocated reference frame, curRefPOC represents a POC of a reference frame of a current CU, and colRefPOC represents a POC of a reference frame of the time domain collocated reference block. It can be learned from the formula (1) that, in order to obtain the scaleMV of the current CU, a difference value (Delta POC for short) between the POC_COL of the frame in which the collocated reference block is located and the colRefPOC of the reference frame of the collocated reference block, and the colMV need to be stored. In the VVC standard, the Delta POC requires 16 bits to store, and the colMV requires 40 bits to store. In the VVC standard, a storage granularity of the Delta POC and the colMV is 8×8. Compared to the storage granularity 16×16 of the previous-generation standard HEVC, a larger memory access bandwidth may be occupied for storing the Delta POC and the colMV of the collocated reference block in the VVC standard.

For the above technical problem in the existing technology, in the embodiment of the present disclosure, a lookup table corresponding to a time domain collocated reference block is established, and the lookup table includes any one of a picture order count difference (Delta POC) lookup table, or a picture order count lookup table of a reference frame. The picture order count difference (Delta POC) lookup table is configured to store a difference between a picture order count and a reference frame picture order count thereof. The picture order count lookup table of the reference frame is configured to store a picture order count of the reference frame. A lookup table corresponding to the time domain collocated reference block is stored, an index corresponding to the lookup table is established, and when decoding is performed according to the coding unit, the stored data is acquired by using the index corresponding to the lookup table from the lookup table corresponding to the time domain collocated reference block. Accordingly, the occupation of the memory access bandwidth in the VVC standard can be greatly reduced.

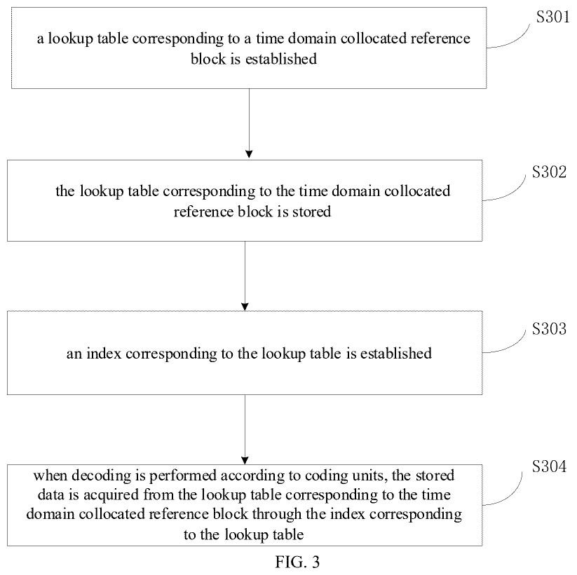

In an exemplary embodiment, as shown in FIG. 3, a method for storing video data is provided, the method can be applied to various devices including video data processing, and the method may include the following steps S301 to S304.

S301: a lookup table corresponding to a time domain collocated reference block is established.

In the embodiment, the VVC standard is taken as an example. When the decoder decodes each frame, a total quantity of reference frames of the decoder does not exceed 16, that is, there are up to 16 cases of the picture order count difference (Delta POC) of all time domain collocated reference blocks or the picture order count (POC) of the reference frame of the time domain collocated reference block. Accordingly, the Delta POC or the reference frame of each time domain collocated reference block may be represented by 4 bits. Based on this, a frame-level Delta POC lookup table or a reference frame POC lookup table of a time domain collocated reference block may be established for all time domain collocated reference blocks. The established lookup table (hereinafter referred to as Delta POC lookup table or reference frame POC lookup table) may store up to 16 Delta POCs or reference frame POCs. For the Delta POC lookup table, each Delta POC requires 16 bits. Accordingly, a total size of the Delta POC lookup table is 256 bits. For the reference frame POC lookup table, each POC requires 32 bits. Accordingly, a total size of the reference frame POC lookup table is 512 bits.

As an example, when the lookup table is the picture order count difference (Delta POC) lookup table, forward and backward reference frame lists of the current frame are transmitted to the decoder. When the current frame is not the B frame, the decoder acquires a picture order count (POC) of each reference frame in the forward reference frame list, subtracts the picture order count of the current frame therefrom to obtain a first picture order count difference, and stores the first picture order count difference into the lookup table corresponding to the time domain collocated reference block.

In the embodiment, the establishment of the Delta POC lookup table is completed at the frame level, that is, completed before one frame is decoded. Before the decoding starts, the software driver may transmit the forward and backward reference frame lists of the current frame to the decoder. The decoder first obtains the POC of each reference frame in the forward reference frame list, and then subtracts the POC of the current frame to obtain the Delta POC.

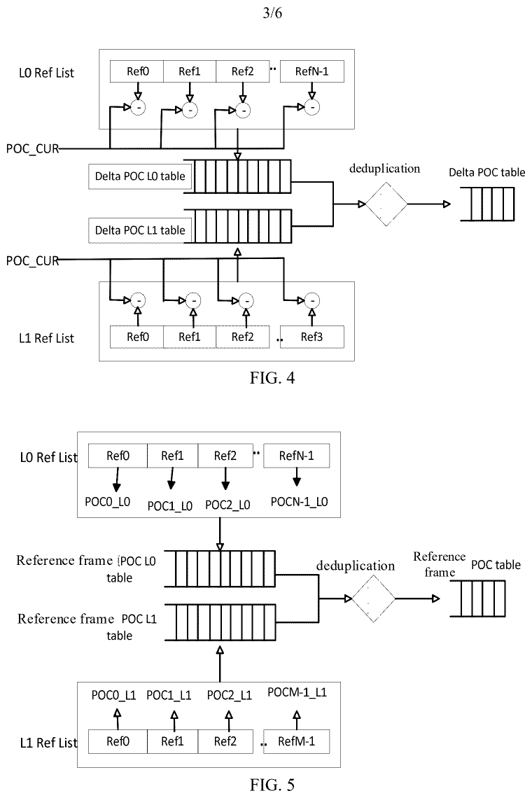

As an example, as shown in FIG. 4, when the current frame is the B frame, the picture order count (for example, Ref0, Ref1, Ref2, . . . , RefN−1, where N is a natural number greater than 1) of each reference frame in the forward reference frame list (L0 Ref List) is acquired by the decoder, and is subtracted by the picture order count of the current frame (POC_CUR) to obtain the first picture order count difference (Delta POC L0 table). The picture order count of each reference frame in the backward reference frame list (L1 Ref List) is acquired by the decoder, and is subtracted by the picture order count of the current frame to obtain a second picture order count difference (Delta POC L1 table). A deduplication operation is performed on the first picture order count difference and the second picture order count difference, to obtain a picture order count difference after the deduplication. The picture order count difference after the deduplication is stored into the lookup table corresponding to the time domain collocated reference block (Delta POC lookup table).

As an example, when the lookup table is the picture order count lookup table of the reference frame, the forward and backward reference frame lists of the current frame are transmitted to the decoder. When the current frame is not the B frame, the picture order count of each reference frame in the forward reference frame list is acquired by the decoder. The picture order count of each reference frame in the forward reference frame list is stored into the lookup table corresponding to the time domain collocated reference block.

As an example, as shown in FIG. 5, when the current frame is the B frame, the picture order count of each reference frame in the forward reference frame list (L0 Ref List) is acquired by the decoder, and the picture order count of each reference frame in the backward reference frame list (L1 Ref List) is acquired by the decoder. The deduplication operation is performed on the picture order count of each reference frame in the forward reference frame list (reference frame POC L0 table) and the picture order count of each reference frame in the backward reference frame list (reference frame POC L1 table), to obtain a picture order count after the deduplication. The picture order count after the deduplication is stored into the lookup table corresponding to the time domain collocated reference block (reference frame POC table).

S302: the lookup table corresponding to the time domain collocated reference block is stored.

In the embodiment, the Delta POC lookup table storing the picture order count difference or the reference frame POC lookup table storing the picture order count is stored into an off-chip memory, and may be read from the off-chip memory when data in the lookup table needs to be acquired.

S303: an index corresponding to the lookup table is established.

In the embodiment, the index corresponding to the lookup table is configured to represent positions of pieces of data stored in the lookup table. A picture order count difference index (Delta POC index) is taken as an example, and a position of a difference (curRefPOC) between a picture order count of a current frame (POC_CUR) and a picture order count of a reference frame (curRefPOC) of each decoding unit in the picture order count difference lookup table is determined according to a preset sequence, and the index of the picture order count difference lookup table is obtained.

For example, the index of the picture order count difference lookup table may be further stored into an on-chip register, a width of the on-chip register is the same as a width of a data bus accessing an off-chip register, and when the on-chip register is full, data in the on-chip register is stored into the off-chip register.

As an example, when the lookup table is the picture order count lookup table of the reference frame, the position of the picture order count of the reference frame of each decoding unit in the picture order count lookup table of the reference frame is determined according to the preset sequence, and the index of the picture order count lookup table of the reference frame is obtained. Similarly, the index of the picture order count lookup table of the reference frame may be stored into the on-chip register, the width of the on-chip register is the same as the width of the data bus accessing the off-chip register, and when the on-chip register is full, data in the on-chip register is stored into the off-chip register.

The preset sequence in the embodiment may be a sequence of corresponding storage addresses of data in a register, wherein the data is stored in the lookup table, or a picture order count of each reference frame in the forward reference frame list, or a picture order count of each reference frame in the backward reference frame list. It should be noted that the preset sequence is not specifically limited by the embodiment, which can be set or adjusted according to an actual situation.

Step 304: when decoding is performed according to coding units, the stored data is acquired from the lookup table corresponding to the time domain collocated reference block through the index corresponding to the lookup table.

In the embodiment, an index corresponding to the picture order count difference lookup table is taken as an example. When the CU decoding is performed, the index corresponding to the picture order count difference lookup table of the collocated reference block (Delta POC index) is employed to look for the picture order count difference lookup table of the collocated reference frame (Delta POC table), to obtain a final picture order count difference (Delta POC). Further, the scaled motion vector may be obtained through the calculation according to the above-mentioned formula (1).

As an example, when the decoding is performed on the current frame, the lookup table corresponding to the time domain collocated reference block and the index of the lookup table corresponding to the time domain collocated reference block are read from the off-chip memory; the read lookup table corresponding to the time domain collocated reference block and index of the lookup table corresponding to the time domain collocated reference block are stored into the on-chip register; the index of the lookup table corresponding to the time domain collocated reference block is read from the on-chip register; the storage position of the difference between the picture order count of the collocated reference block and the picture order count of the reference frame of the collocated reference block in the lookup table corresponding to the time domain collocated reference block, or the storage position of the picture order count of the reference frame of the collocated reference block in the lookup table corresponding to the time domain collocated reference block is determined according to the index of the lookup table corresponding to the time domain collocated reference block; and the difference between the picture order count of the collocated reference block and the picture order count of the reference frame of the collocated reference block, or the picture order count of the reference frame of the collocated reference block is acquired from the corresponding storage position.

As an example, it is assumed that a decoding speed of the decoder is 60 fps, the method in the embodiment of the present disclosure is applied, and the memory access bandwidth occupied by the decoding with the resolution 4096×2160 is provided as follows:

$$DeltaPocIdxSize\_VVC = 4096 \times 2160 \times 4 = 552960 bit \\ BandWR\_VVC = DeltaPocIdxSize\_VVC \times 60 \times 2 \approx 66.255 Mbit / s$$

where BandWR_VVC represents the memory access bandwidth occupied in the VVC standard, and DeltaPocIdxSize_VVC represents a data volume of the index of the Delta POC of one frame of collocated reference block stored in the VVC standard.

In the above-mentioned method for storing the video data, a lookup table corresponding to a time domain collocated reference block is established, the lookup table includes any one of a picture order count difference lookup table, or a picture order count lookup table of a reference frame. The picture order count difference lookup table is configured to store a difference between a picture order count and a reference frame picture order count thereof. The picture order count lookup table of the reference frame is configured to store a picture order count of the reference frame. Accordingly, the picture order count difference and the picture order count of the reference frame may be stored in the mode of data table, so that an index is subsequently established for looking up. By storing the lookup table corresponding to the time domain collocated reference block, and establishing an index corresponding to the lookup table, so that multiple different picture order count differences and reference frame picture order counts can be looked up in an index mode, and only the index of the lookup table can be stored in the on-chip register, thereby greatly reducing the occupation of memory access bandwidth in the VVC standard. When decoding is performed according to the coding units, the stored data is acquired by using the index corresponding to the lookup table from the lookup table corresponding to the time domain collocated reference block. Accordingly, a memory access bandwidth occupied by a position in a frame-level picture order count difference lookup table is allowed to be only one-fourth of a memory access bandwidth occupied by a directly stored picture order count difference, thereby effectively reducing the memory access bandwidth and improving the image display performance.

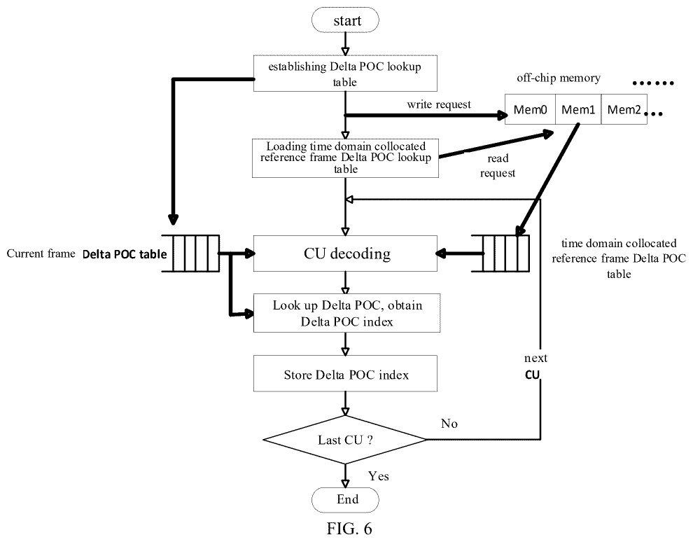

In another exemplary embodiment, as shown in FIG. 6, an implementation procedure of a Delta POC lookup table is provided, which may include steps S601 to S606.

S601: a Delta POC lookup table is established.

For the specific implementation process and technical effect of step S601 in the embodiment, reference can be made to the related description of the step S301 in the method embodiment shown in FIG. 3, and details are not described herein again.

S602: a time domain collocated reference frame Delta POC lookup table is loaded.

In the embodiment, after the Delta POC lookup table is established, a write request may be transmitted to the off-chip memory, to instruct to store the established Delta POC lookup table into the off-chip memory. When the time domain collocated reference frame Delta POC lookup table needs to be loaded, a read request may be transmitted to the off-chip memory to instruct to load the time domain collocated reference frame Delta POC lookup table from the off-chip memory.

S603: decoding is performed in units of CUs.

In the embodiment, decoding processing is performed in units of CUs, a decoder acquires a current frame Delta POC table and a time domain collocated reference frame Delta POC table, accordingly a storage position of the Delta POC is acquired.

S604: the Delta POC is looked up to obtain a Delta POC index.

In the embodiment, the Delta POC index is established according to the storage position of the Delta POC. For the specific implementation process, reference can be made the related description of the step S303 in the method embodiment shown in FIG. 3, and details are not described herein again.

S605: the Delta POC index is stored.

In the embodiment, since the Delta POC index may copy much less memory access bandwidth than directly storing the Delta POC, the Delta POC index can be stored in the on-chip register.

S606: it is determined whether a current CU is the last CU, and the procedure ends when the current CU is the last CU; or when the current CU is not the last CU, the decoding is performed on the next CU, and the procedure returns to the step S603.

In the embodiment, the Delta POC lookup table and the Delta POC index are established, the Delta POC lookup table is stored in the off-chip register, and the Delta POC index is stored in the on-chip register, so that the Delta POC stored in the Delta POC lookup table can be looked up through the Delta POC index. Compared to the solution of directly storing the Delta POC, the technical solution in the embodiment can significantly reduce the memory access bandwidth and improve the image display performance.

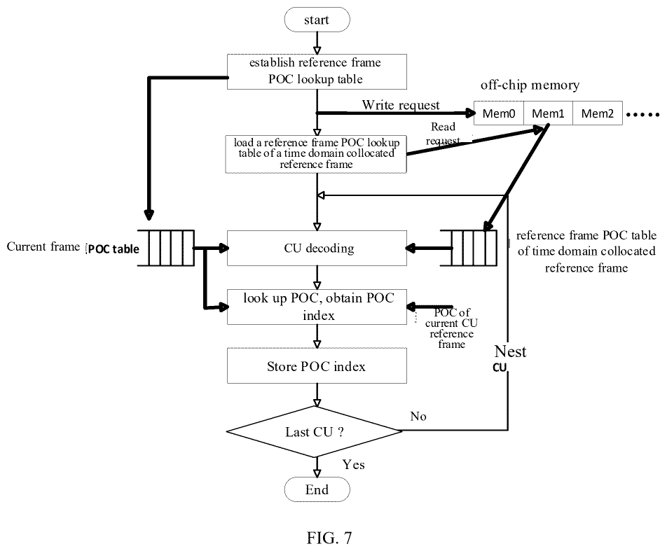

In another exemplary embodiment, as shown in FIG. 7, an implementation procedure of a reference frame POC lookup table is provided, which may include steps S701 to S706.

S701: a reference frame POC lookup table is established.

For the specific implementation process and technical effect of the step S701 in the embodiment, reference can be made to the related description of step S301 in the method embodiment shown in FIG. 3, and details are not described herein again.

S702: a reference frame POC lookup table of a time domain collocated reference frame is loaded.

In the embodiment, after the reference frame POC lookup table is established, a write request may be transmitted to the off-chip memory, to instruct to store the established reference frame POC lookup table in the off-chip memory. When the reference frame POC lookup table of the time domain collocated reference frame needs to be loaded, a read request may be transmitted to the off-chip memory to instruct to load the reference frame POC lookup table of the time domain collocated reference frame from the off-chip memory.

S703: decoding is performed on CUs.

In the embodiment, the decoding processing is performed in units of CUs, the decoder acquires a current reference frame POC table (picture order count table) and the reference frame POC table of the time domain collocated reference frame, accordingly a storage position of the reference frame POC is acquired.

S704: a POC is looked up to obtain a POC index.

In the embodiment, the POC index is established according to a storage position of the reference frame POC. For the specific implementation process, reference can be made to the related description of the step S303 in the method embodiment shown in FIG. 3, and details are not described herein again.

S705: the POC index is stored.

In the embodiment, compared to directly storing the reference frame POC, the memory access bandwidth occupied by the POC index is greatly reduced. Accordingly, the POC index may be stored in the on-chip register.

S706: it is determined whether a current CU is the last CU, and the procedure ends when the current CU is the last CU; or when the current CU is not the last CU, the decoding is performed on the next CU, and the procedure returns to the step S703.

In the embodiment, the reference frame POC lookup table and the POC index are established, the reference frame POC lookup table is stored in the off-chip memory, and the POC index is stored in the on-chip register, so that the POC stored in the reference frame POC lookup table can be looked up through the POC index. Compared to the solution of directly storing the POC, the technical solution in the embodiment can significantly reduce the memory access bandwidth and improve the image display performance.

It should be appreciated that, although steps in the flow charts related to the foregoing embodiments are sequentially displayed in an order indicated by arrows, these steps are not definitely sequentially performed according to the order indicated by arrows. Unless expressly stated in the specification, these steps are not performed in a strict order, and these steps may be performed in another order. In addition, at least a part of steps in the flow charts involved in the foregoing embodiments may include multiple steps or multiple phases. These steps or phases are not definitely performed at the same moment, but may be performed at different moments. These steps or phases are not definitely performed in sequence, but may be performed in turn or alternately with other steps or at least a part of steps or phases in other steps.

Based on the same inventive concept, in an embodiment of the present disclosure, an apparatus for storing video data configured to implement the foregoing method for storing video data is provided. An implementation solution provided by the apparatus is similar to that described in the foregoing method. Accordingly, for the specific limitations in the following provided one or more embodiments of the apparatus for storing video data, reference can be made to the foregoing limitations on the method for storing the video data, and the details are not described herein again.

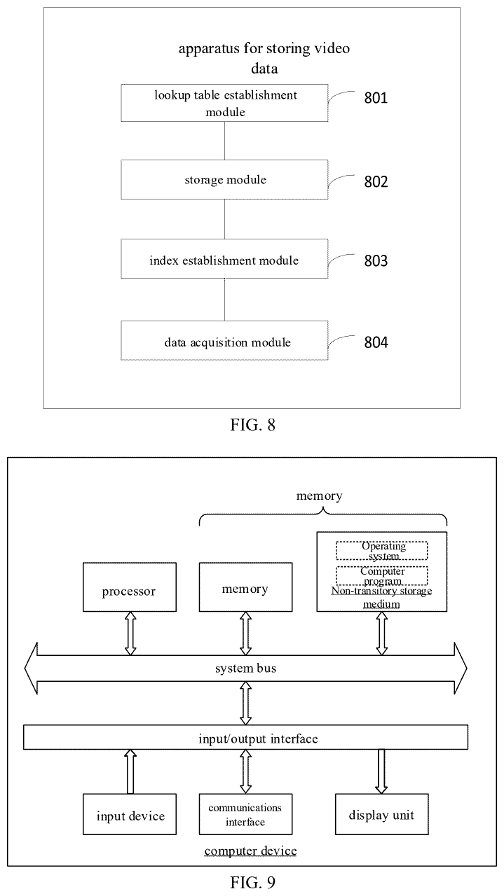

In an exemplary embodiment, as shown in FIG. 8, an apparatus for storing video data is provided, which may include a lookup table establishment module 801, a storage module 802, an index establishment module 803, and a data acquisition module 804.

The lookup table establishment module 801 is configured to establish a lookup table corresponding to a time domain collocated reference block. The lookup table includes any one of a picture order count difference lookup table, or a picture order count lookup table of a reference frame. The picture order count difference lookup table is configured to store a difference between a picture order count and a reference frame picture order count thereof. The picture order count lookup table of the reference frame is configured to store a picture order count of the reference frame.

The storage module 802 is configured to store the lookup table corresponding to the time domain collocated reference block.

The index establishment module 803 is configured to establish an index corresponding to the lookup table.

The data acquisition module 804 is configured to: when decoding is performed according to coding units, acquire stored data from the lookup table corresponding to the time domain collocated reference block through the index corresponding to the lookup table.

As an example, when the lookup table is a picture order count difference lookup table, the lookup table establishment module 801 is specifically configured to: transmit forward and backward reference frame lists of a current frame to a decoder; acquire, through the decoder, a picture order count of each reference frame in the forward reference frame list when the current frame is not the B frame, subtract the picture order count of the current frame therefrom to obtain a first picture order count difference; store the first picture order count difference into the lookup table corresponding to the time domain collocated reference block; when the current frame is the B frame, acquire, by the decoder, the picture order count of each reference frame in the forward reference frame list, and subtract the picture order count of the current frame to obtain a first picture order count difference; acquire, by the decoder, a picture order count of each reference frame in the backward reference frame list, and subtract the picture order count of the current frame to obtain a second picture order count difference; perform a deduplication operation on the first picture order count difference and the second picture order count difference, obtain a picture order count difference after the deduplication; and store the picture order count difference after the deduplication into the lookup table corresponding to the time domain collocated reference block.

As an example, when the lookup table is the picture order count lookup table of the reference frame, the lookup table establishment module 801 is specifically configured to: transmit the forward and backward reference frame lists of the current frame to the decoder; when the current frame is not the frame B, acquire, through the decoder, the picture order count of each reference frame in the forward reference frame list, store the picture order count of each reference frame in the forward reference frame list into the lookup table corresponding to the time domain collocated reference block; when the current frame is the frame B, acquire, through the decoder, the picture order count of each reference frame in the forward reference frame list, and acquire, through the decoder, the picture order count of each reference frame in the backward reference frame list; perform the deduplication operation on the picture order count of each reference frame in the forward reference frame list and the picture order count of each reference frame in the backward reference frame list, obtain a picture order count after the deduplication; and store the picture order count after the deduplication into the lookup table corresponding to the time domain collocated reference block.

As an example, the storage module 802 is specifically configured to store the lookup table corresponding to the time domain collocated reference block into an off-chip memory.

As an example, when the lookup table is the picture order count difference lookup table, the index establishment module 803 is specifically configured to: determine a position of a difference between a picture order count of a current frame and a picture order count of a reference frame of each decoding unit in the picture order count difference lookup table according to a preset sequence, and obtain an index of the picture order count difference lookup table; store the index of the picture order count difference lookup table into the on-chip register, in which a width of the on-chip register is the same as a width of a data bus accessing the off-chip memory, and store data in the on-chip register into the off-chip memory when the on-chip register is full.

As an example, when the lookup table is the picture order count lookup table of the reference frame, the index establishment module 803 is specifically configured to: determine the position of the picture order count of the reference frame of each decoding unit in the picture order count lookup table of the reference frame according to the preset sequence, and obtain the index of the picture order count lookup table of the reference frame; store the index of the picture order count lookup table of the reference frame into the on-chip register, in which the width of the on-chip register is the same as the width of the data bus accessing the off-chip memory, and store data in the on-chip register into the off-chip memory when the on-chip register is full.

As an example, the data acquisition module 804 is specifically configured to: when the decoding is performed on the current frame, read the lookup table corresponding to the time domain collocated reference block and the index of the lookup table corresponding to the time domain collocated reference block from the off-chip memory, store the read lookup table corresponding to the time domain collocated reference block and index of the lookup table corresponding to the time domain collocated reference block into the on-chip register; read the index of the lookup table corresponding to the time domain collocated reference block from the on-chip register; determine the storage position of the difference between the picture order count of the collocated reference block and the picture order count of the reference frame of the collocated reference block in the lookup table corresponding to the time domain collocated reference block, or the storage position of the picture order count of the reference frame of the collocated reference block in the lookup table corresponding to the time domain collocated reference block according to the index of the lookup table corresponding to the time domain collocated reference block; and acquire the difference between the picture order count of the collocated reference block and the picture order count of the reference frame of the collocated reference block, or the picture order count of the reference frame of the collocated reference block from the corresponding storage position.

All modules in the above-mentioned apparatus for storing video data may be implemented in whole or in part by using software, hardware, and a combination thereof. The modules may be embedded in or independent of a processor in the computer device in a hardware form, or may be stored in a memory in the computer device in a software form, so that the processor invokes to execute operations corresponding to the modules.

In an exemplary embodiment, a computer device is provided. The computer device may be a terminal, and an internal structure diagram of the computer device may be as shown in FIG. 9. The computer device may include a processor, a memory, an input/output interface, a communication interface, a display unit, and an input device. The processor, the memory, and the input/output interface are connected to the system bus through the system bus, and the communication interface, the display unit, and the input/output device are connected to the system bus through the input/output interface. The processor of the computer device is configured to provide computing and control capabilities. The memory of the computer device may include a non-transitory storage medium and an internal memory. The non-transitory storage medium stores an operating system and a computer program. The internal storage provides an environment for running an operating system and a computer program in the non-transitory storage medium. The input/output interface of the computer device is configured to exchange information between the processor and an external device. The communication interface of the computer device is configured to communicate with an external terminal in a wired or wireless manner. The wireless manner may be implemented through WIFI, a mobile cellular network, Near Field Communication (NFC), or other technologies. The computer program is executed by a processor to implement a method for storing video data. The display unit of the computer device is configured to form a visual picture, which may be a display screen, a projection apparatus, or a virtual reality imaging apparatus. The display screen may be a liquid crystal display screen or an electronic ink display screen. An input device of the computer device may be a touch layer covering the display screen, or may be a key, a trackball, or a touchpad provided on a housing of the computer device, or may be an external keyboard, a touchpad, or a mouse, etc.

Those skilled in the art may understand that the structure shown in FIG. 9 is merely a block diagram of partial structure related to the solution of the present disclosure, and does not constitute a limitation on a computer device to which the solution of the present disclosure is applied. A specific computer device may include more or fewer components than that shown in the figure, or combine some components, or have different component arrangements.

In an exemplary embodiment, a computer device is provided, which may include a processor and a memory storing a computer program, and the processor, when executing the computer program, may implement the steps in the above-mentioned method embodiments.

In an embodiment, a computer-readable storage medium is provided, on which a computer program is stored. The computer program, when executed by a processor, may cause the processor to implement the steps in the above-mentioned method embodiments.

In an embodiment, a computer program product is provided, which may include a computer program. The computer program, when executed by a processor, may cause the processor to implement the steps in the above-mentioned method embodiments.

It should be noted that user information (including but not limited to user device information, user personal information, and the like) and data (including but not limited to data used for analysis, stored data, and displayed data) involved in the present disclosure are information and data that are authorized by a user or that are fully authorized by each party, and collection, use, and processing of related data need to comply with a related regulation.

A person of ordinary skill in the art can understand that all or part of the processes in the above-mentioned embodiments of the method can be implemented by instructing related hardware through a computer program. The computer program may be stored in a non-transitory computer-readable storage medium. When the computer program is executed, the processes of the embodiments of the above-mentioned method are included. Any reference to a memory, a database, or other medium used in the embodiments provided in the present application may include at least one of a non-transitory memory and a transitory memory. The non-transitory memory may include a read-only memory (ROM), a magnetic tape, floppy disk, a flash memory, an optical storage, a high-density embedded non-transitory memory, a resistive random access memory (ReRAM), a magnetoresistive random access memory (MRAM), a ferroelectric random access memory (FRAM), a phase change memory (PCM), a graphene memory, etc. The transitory memory may include a random access memory (RAM) or an external cache memory, etc. By way of illustration and not limitation, the RAM may be in various forms, such as a static random access memory (SRAM) or a dynamic random access memory (DRAM). The database involved in each embodiment of the present disclosure may include at least one of a relational database and a non-relational database. The non-relational database may include, but is not limited to, a distributed database based on blockchain. The processor involved in each embodiment of the present disclosure may be a general-purpose processor, a central processing unit, a graphics processor, a digital signal processor, a programmable logic unit, a data processing logic unit based on quantum computing, artificial intelligence (AI) processor, etc., but is not limited thereto.

The technical features in the above embodiments may be combined arbitrarily. In order to make the description concise, all possible combinations of the technical features in the above embodiments are not described. However, as long as there is no contradiction in the combinations of these technical features, these combinations should be considered to be within the scope of the present application.

The above-described embodiments only express several implementation modes of the present disclosure, and the descriptions are relatively specific and detailed, but should not be construed as limiting the scope of the present disclosure. It should be noted that, those of ordinary skill in the art can make several modifications and improvements without departing from the concept of the present disclosure, and these all fall within the protection scope of the present disclosure. Therefore, the protection scope of the present disclosure should be subject to the appended claims.

1. A method for storing video data, comprising:
establishing a lookup table corresponding to a time domain collocated reference block, wherein the lookup table comprises any one of a picture order count difference lookup table, or a picture order count lookup table of a reference frame, the picture order count difference lookup table is configured to store a difference between a picture order count and a reference frame picture order count thereof, and the picture order count lookup table of the reference frame is configured to store a picture order count of the reference frame;
storing the lookup table corresponding to the time domain collocated reference block;
establishing an index corresponding to the lookup table; and
when decoding is performed according to coding units, acquiring stored data from the lookup table corresponding to the time domain collocated reference block through the index corresponding to the lookup table.

2. The method according to claim 1, wherein when the lookup table is the picture order count difference lookup table, establishing the lookup table corresponding to the time domain collocated reference block comprises:
transmitting forward and backward reference frame lists of a current frame to a decoder;
when the current frame is not a frame B, acquiring, through the decoder, a picture order count of each reference frame in the forward reference frame list, subtracting the picture order count of the current frame therefrom to obtain a first picture order count difference, storing the first picture order count difference into the lookup table corresponding to the time domain collocated reference block;
when the current frame is the frame B, acquiring, by the decoder, the picture order count of each reference frame in the forward reference frame list, subtracting the picture order count of the current frame to obtain the first picture order count difference, acquiring, through the decoder, a picture order count of each reference frame in the backward reference frame list, subtracting the picture order count of the current frame to obtain a second picture order count difference, performing a deduplication operation on the first picture order count difference and the second picture order count difference, obtaining a picture order count difference after the deduplication, and storing the picture order count difference after the deduplication into the lookup table corresponding to the time domain collocated reference block.

3. The method according to claim 1, wherein when the lookup table is the picture order count lookup table of the reference frame, establishing the lookup table corresponding to the time domain collocated reference block comprises:
transmitting forward and backward reference frame lists of a current frame to a decoder;
when the current frame is not a frame B, acquiring, through the decoder, a picture order count of each reference frame in the forward reference frame list, storing the picture order count of each reference frame in the forward reference frame list into the lookup table corresponding to the time domain collocated reference block;
when the current frame is the frame B, acquiring, through the decoder, the picture order count of each reference frame in the forward reference frame list, acquiring, through the decoder, a picture order count of each reference frame in the backward reference frame list, performing a deduplication operation on the picture order count of each reference frame in the forward reference frame list and the picture order count of each reference frame in the backward reference frame list, obtaining a picture order count after the deduplication, and storing the picture order count after the deduplication into the lookup table corresponding to the time domain collocated reference block.

4. The method according to claim 1, wherein storing the lookup table corresponding to the time domain collocated reference block comprises:
storing the lookup table corresponding to the time domain collocated reference block into an off-chip memory.

5. The method according to claim 1, wherein when the lookup table is the picture order count difference lookup table, establishing the index corresponding to the lookup table comprises:
determining a position of a difference between a picture order count of a current frame and a picture order count of a reference frame of each decoding unit in the picture order count difference lookup table according to a preset sequence, obtaining an index of the picture order count difference lookup table;
storing the index of the picture order count difference lookup table into an on-chip register, wherein a width of the on-chip register is the same as a width of a data bus accessing an off-chip memory, and storing data in the on-chip register into the off-chip memory when the on-chip register is full.

6. The method according to claim 1, wherein when the lookup table is the picture order count lookup table of the reference frame, establishing the index corresponding to the lookup table comprises:
determining a position of a picture order count of a reference frame of each decoding unit in the picture order count lookup table of the reference frame according to a preset sequence, obtaining an index of the picture order count lookup table of the reference frame;
storing the index of the picture order count lookup table of the reference frame into an on-chip register, wherein a width of the on-chip register is the same as a width of a data bus accessing an off-chip memory, and storing data in the on-chip register into the off-chip memory when the on-chip register is full.

7. The method according to claim 5, wherein acquiring the stored data from the lookup table corresponding to the time domain collocated reference block through the index corresponding to the lookup table comprises:
when the decoding is performed on the current frame, reading the lookup table corresponding to the time domain collocated reference block and the index of the lookup table corresponding to the time domain collocated reference block from the off-chip memory;
storing the read lookup table corresponding to the time domain collocated reference block and index of the lookup table corresponding to the time domain collocated reference block into the on-chip register;
reading the index of the lookup table corresponding to the time domain collocated reference block from the on-chip register;
determining a storage position of the difference between the picture order count of the collocated reference block and the picture order count of the reference frame of the collocated reference block in the lookup table corresponding to the time domain collocated reference block, or a storage position of the picture order count of the reference frame of the collocated reference block in the lookup table corresponding to the time domain collocated reference block according to the index of the lookup table corresponding to the time domain collocated reference block; and
acquiring the difference between the picture order count of the collocated reference block and the picture order count of the reference frame of the collocated reference block, or the picture order count of the reference frame of the collocated reference block from the corresponding storage position.

8. An apparatus for storing video data, comprising:
a lookup table establishment module, configured to establish a lookup table corresponding to a time domain collocated reference block, wherein the lookup table comprises any one of a picture order count difference lookup table, or a picture order count lookup table of a reference frame, the picture order count difference lookup table is configured to store a difference between a picture order count and a reference frame picture order count thereof, the picture order count lookup table of the reference frame is configured to store a picture order count of the reference frame;
a storage module, configured to store the lookup table corresponding to the time domain collocated reference block;
an index establishment module, configured to establish an index corresponding to the lookup table; and
a data acquisition module, configured to acquire stored data from the lookup table corresponding to the time domain collocated reference block through the index corresponding to the lookup table when decoding is performed according to coding units.

9. The apparatus according to claim 8, wherein when the lookup table is the picture order count difference lookup table, the lookup table establishment module is configured to:
transmit forward and backward reference frame lists of a current frame to a decoder; acquire, through the decoder, a picture order count of each reference frame in the forward reference frame list when the current frame is not the B frame, subtract the picture order count of the current frame therefrom to obtain a first picture order count difference; store the first picture order count difference into the lookup table corresponding to the time domain collocated reference block; when the current frame is the B frame, acquire, by the decoder, the picture order count of each reference frame in the forward reference frame list, and subtract the picture order count of the current frame to obtain a first picture order count difference; acquire, by the decoder, a picture order count of each reference frame in the backward reference frame list, and subtract the picture order count of the current frame to obtain a second picture order count difference; perform a deduplication operation on the first picture order count difference and the second picture order count difference, obtain a picture order count difference after the deduplication; and store the picture order count difference after the deduplication into the lookup table corresponding to the time domain collocated reference block.

10. The apparatus according to claim 8, wherein when the lookup table is the picture order count lookup table of the reference frame, the lookup table establishment module is configured to:
transmit the forward and backward reference frame lists of the current frame to the decoder; when the current frame is not the frame B, acquire, through the decoder, the picture order count of each reference frame in the forward reference frame list, store the picture order count of each reference frame in the forward reference frame list into the lookup table corresponding to the time domain collocated reference block; when the current frame is the frame B, acquire, through the decoder, the picture order count of each reference frame in the forward reference frame list, and acquire, through the decoder, the picture order count of each reference frame in the backward reference frame list; perform the deduplication operation on the picture order count of each reference frame in the forward reference frame list and the picture order count of each reference frame in the backward reference frame list, obtain a picture order count after the deduplication; and store the picture order count after the deduplication into the lookup table corresponding to the time domain collocated reference block.

11. The apparatus according to claim 8, wherein the storage module is configured to store the lookup table corresponding to the time domain collocated reference block into an off-chip memory.

12. The apparatus according to claim 8, wherein when the lookup table is the picture order count difference lookup table, the index establishment module is configured to:
determine a position of a difference between a picture order count of a current frame and a picture order count of a reference frame of each decoding unit in the picture order count difference lookup table according to a preset sequence, and obtain an index of the picture order count difference lookup table; store the index of the picture order count difference lookup table into the on-chip register, in which a width of the on-chip register is the same as a width of a data bus accessing the off-chip memory, and store data in the on-chip register into the off-chip memory when the on-chip register is full.

13. The apparatus according to claim 8, wherein when the lookup table is the picture order count lookup table of the reference frame, the index establishment module is configured to:
determine the position of the picture order count of the reference frame of each decoding unit in the picture order count lookup table of the reference frame according to the preset sequence, and obtain the index of the picture order count lookup table of the reference frame; store the index of the picture order count lookup table of the reference frame into the on-chip register, in which the width of the on-chip register is the same as the width of the data bus accessing the off-chip memory, and store data in the on-chip register into the off-chip memory when the on-chip register is full.

14. The apparatus according to claim 12, wherein the data acquisition module is configured to:
when the decoding is performed on the current frame, read the lookup table corresponding to the time domain collocated reference block and the index of the lookup table corresponding to the time domain collocated reference block from the off-chip memory, store the read lookup table corresponding to the time domain collocated reference block and index of the lookup table corresponding to the time domain collocated reference block into the on-chip register; read the index of the lookup table corresponding to the time domain collocated reference block from the on-chip register; determine the storage position of the difference between the picture order count of the collocated reference block and the picture order count of the reference frame of the collocated reference block in the lookup table corresponding to the time domain collocated reference block, or the storage position of the picture order count of the reference frame of the collocated reference block in the lookup table corresponding to the time domain collocated reference block according to the index of the lookup table corresponding to the time domain collocated reference block; and acquire the difference between the picture order count of the collocated reference block and the picture order count of the reference frame of the collocated reference block, or the picture order count of the reference frame of the collocated reference block from the corresponding storage position.

15. A computer device, comprising a processor and a memory storing a computer program, wherein the processor, when executing the computer program, implements the method of claim 1.

16. A non-transitory computer-readable storage medium, on which a computer program is stored, wherein the computer program, when executed by a processor, causes the processor to implement the method of claim 1.

17. A non-transitory computer program product, comprising a computer program, wherein the computer program, when executed by a processor, causes the processor to implement the method of claim 1.
